(19) United States
(12) Patent Application Publication
(10) Pub. No.: US 2025/0153196 A1
(43) Pub. Date: May 15, 2025

(54) FLUIDIC CIRCUIT FOR UNIFORM, HIGH VELOCITY SPRAY ACROSS A RANGE OF OPERATING TEMPERATURES

(71) Applicant: ABC Technologies Inc., North York (CA)

(72) Inventors: Chunling Zhao, Ellicott City, MD (US); Alexander Dotzler, Potomac, MD (US)

(21) Appl. No.: 18/941,195

(22) Filed: Nov. 8, 2024

Related U.S. Application Data
(60) Provisional application No. 63/548,044, filed on Nov. 10, 2023.

(51) Int. Cl. B05B 1/08

(52) U.S. Cl. CPC B05B 1/08

(57) ABSTRACT

A fluidic geometry to produce uniform oscillating sprays is described. The geometry can be embodied as an insert, housing, or system in which an inlet feeds an interaction chamber. A major island is disposed at the upstream end of that chamber so as to create two power nozzles that are positioned off of the centerline axis and downstream of the major island. A minor island is also disposed within the interaction chamber, but remains spaced apart and downstream of the major island so as to define an exchange channel. The exchange channel creates an inertance effect that can be controlled and adjusted so as to provide the desired oscillating spray fan produced by the geometry. This arrangement exhibits consistent cold and high temperature performance for a range of fluid compositions and operating conditions.

### CROSS REFERENCE TO RELATED APPLICATIONS

This application claims priority to U.S. provisional patent application Ser. No. 63/548,044 filed on Nov. 10, 2023, which is incorporated by reference herein.

### FIELD OF INVENTION

This invention relates to fluidic systems, components, and apparatus capable of producing controllable, oscillating spray patterns and, more particularly, to a fluidic geometry to generate precisely controlled sprays at colder temperatures usually associated with higher viscosity fluids.

### BACKGROUND

U.S. Pat. No. 6,186,409 (which is incorporated by reference) provides an example of a fluidic system colloquially known as having a “mushroom” configuration. In this patent, a chip or insert has a pattern of apertures formed within one of its surfaces, with the expectation that insert is sealingly received within housing that receives fluid, feeds the fluid into an inlet or plenum formed on the insert, and then has the outlet of the insert aligned with an aperture in the housing so that the housing dispenses a spray fan from that aperture. Owing to the geometric configuration formed on the insert, the dispensed spray may oscillate or otherwise possess specific characteristics.

Many other fluidic geometries are known, so that the mushroom configuration serves as merely one example. However, it is instructive insofar as it (like these other geometries) possesses the features needed to produce oscillating sprays. Specifically, the inlet/feed leads to a passage which optionally has a series of spaced apart posts that help to filter unwanted debris from the fluid. Downstream from these posts, the passage is divided by an “island” that diverts fluid into one of two opposing power nozzles. The power nozzles constrict flow and eject side/angled jets into an interaction or oscillation chamber having a curved or dome-like shape (defined by the downstream facing of the island and the perimeter walls of the insert/housing. Upon entering this chamber, the fluid jets from the power nozzles interact to produce turbulent and shifting flow patterns. Thus, upon exiting through the outlet at the downstream edge of the insert, the fluid is dispensed as a fan-shaped cone in which a jet moves (i.e., oscillates) so as to create a spray (in this particular example, one that is known as “heavy ended,” as will be described in greater detail below) that is useful in various cleaning operations.

U.S. Pat. Nos. 7,472,848 and 7,267,290 describe further improvements and embodiments of other oscillating geometries and inserts, while U.S. Pat. Nos. 6,253,782; 11,305,297; and 11,712,707 depict a “reverse mushroom” configuration in which interaction chamber has angled or curved sidewalls along its downstream section while the power nozzles (and possibly even their corresponding feeds or inlets) are positioned closer to the outlet and at an upstream angle in comparison to a conventional mushroom. U.S. Pat. No. 9,987,639 describes structures that can be implemented in outlet/throat to produce specific effects, while United States' patent publication 2021/0114044 discloses features on and/or in the interaction chamber. All of these patents are also incorporated by reference.

Another example of a fluidic geometry (“three jet island”) can be found in U.S. Pat. Nos. 7,651,036 and 10,532,367, which are incorporated by reference, as well as schematically shown in FIG. 4B (including arrows representing fluid flow/turbulence). The common feature in both these patents relates to the positioning of three individual islands between the inlet and the interaction chamber. Thus, in comparison to the mushroom configuration noted above, an additional power nozzle PN3 is effectively provided on the centerline of the circuit between and above the location of power nozzles PN1, PN2. A small island IS3 is also positioned downstream from power nozzle PN3. Inlet IN3, plenum or flow channel FC3, interaction chamber IC3, and outlet OT3 are similar to other geometries noted herein. This arrangement produces a more uniform oscillating spray pattern, particularly in comparison to the heavy-ended mushroom circuit.

A comparative schematic of how the volumetric breakdown can be visualized is shown in FIG. 1A, in which the percentage of total volume of spray produced over time is plotted on the y-axis and the x-axis is a comparative representation of the position of in the spray fan itself (i.e., the extreme left edge is representative of the volume dispensed at that edge of the fan, the middle showing volume detected at the centerline, etc.). Mushroom circuit distribution M displays a heavy-ended distribution (having an M-shape) so that more volume is delivered at the edges of the spray pattern. Insofar as some applications may require an equal distribution across the entire fan, the three jet island distribution J retains some the “smoothness” and M-shape of the mushroom distribution, but with a smaller difference in the maximum and minimum volumes. For the sake of comparison, a conventional “feedback loop” circuit's distribution F is also depicted, with its most notable feature being the variability and comparative non-uniformity (or jagged/non-smooth) distribution occurring across its middle section). Thus, it will be understood that fluidic circuits producing oscillating sprays can and should be further optimized based upon the volumetric output of the spray fan, and significant differences exist between known and established fluidic geometries (e.g., mushroom vs. three jet island, etc.).

Additionally, with the growing prominence/need for cleaning of sensors and camera systems, particularly in vehicles and other installations exposed to varying and/or extreme weather conditions, there is a growing need for fluidic circuits that are capable of producing and maintaining spray characteristics over a range of temperatures (e.g., from −30° C. up to 75° C.) and fluid types (e.g., water, ethanol, methanol, isoproponal, ethylene glycol, etc.). Similarly, these systems may need to accommodate fluids having different viscosities (e.g., 9 Cp up to 23 Cp or more), as well as being provided over a range of flow rates (e.g., less than 400 mL/min at 22 psi). FIGS. 1B and 1C provide insights and exemplary information on the range of conditions that are typically required/encountered, with the curves M25, M50 and I25, I50 respectively showing the viscosity changes over temperature for mixtures of 25% and 50% methanol (balance being water) and 25% and 50% isopropanol (balance being water) exhibiting a larger range of variation in comparison to M75, M100 (75% and 100% methanol) and I75, I100 (75% and 100% isopropanol). FIG. 1D provides more direct comparative insights, by showing corresponding 50/50 mixes of methanol (M50) vs. ethanol (E50) (balance being water in each case), as well as highlighting more clearly how mixtures of water and longer chain alcohols exhibit markedly higher viscosity at low temperatures. Because it is known in this field that fluidic performance can be impacted by viscosity, it will be understood that fluidic geometry designs must also take into account expected temperature fluctuations.

In the automotive industry, anti-freezing agents used in cleaning solutions will vary by region and/or regulatory scheme. Thus, various alcohols (ethanol, isopropanol, methanol, etc.) may be mixed with water or other aqueous/miscible solutions at a variety of ratios (e.g., 50/50, 75/25, etc.). Further, insofar as operating conditions routinely vary from −20° C. up to in excess of 45° or 50° C., the viscosity of fluids passing through the fluidic geometry can vary by a factor of 3 or more (with higher viscosities encountered at lower temperatures).

In view of the foregoing, a fluidic geometry, insert, and/or system that produces reliable, oscillating sprays at a wide range of operating parameters (e.g., temperature, viscosity of fluid, low vs. high flow rates, desired size/shape/volumetric distribution of the spray fan, etc.) would be welcomed. Specifically, a geometry is needed that will produce uniform spray patterns while taking into account the various different fluids, flow rates, and operating temperatures commonly encountered by vehicles around the globe.

### SUMMARY OF INVENTION

A fluidic geometry is formed on insert and/or as part of a housing or system. One or more inlets feed an interaction chamber having a major island is disposed at the upstream end of that chamber with a minor island spaced apart and downstream of the major island so as to define an exchange channel within the interaction chamber. Two power nozzles, positioned off of the centerline axis, feed the interaction chamber and the exchange channel. The lateral edges of the minor island are positioned so to be within the direct path of each power nozzle, and the minor island itself may possess a crescent, a C-shape, or a “speed bump,” all aligned on the centerline axis at an upstream position from the throat and the outlet. The exchange channel creates an inertance effect that can be controlled and adjusted so as to provide the desired oscillating spray fan produced by the geometry. This arrangement exhibits consistent cold and high temperature performance for a range of fluid compositions and operating conditions.

### DESCRIPTIONS OF THE DRAWINGS

The appended drawings form part of this specification, and any information on/in the drawings is both literally encompassed (i.e., the actual stated values) and relatively encompassed (e.g., ratios for respective dimensions of parts, generalized comparatives, etc.). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure, including selected drawings which may be drawn to scale.

FIG. 1A is a comparative plot of the volumetric distribution of sprays produced by a variety of fluidic geometries. FIGS. 1B and 1C plot the relationship between the viscosity of selected fluids (i.e., methanol and isopropanol, respectively speaking) across a range of temperatures and mixtures of the alcohol in question with water (i.e., pure (100%) alcohol, 75/25 alcohol/water, etc.), including formulae for each curve/set of conditions. FIG. 1D is a combined comparative plot of the relationship of viscosity and temperature for 50/50 ethanol/water (line E50) and 50/50 methanol/water (line M50).

FIGS. 2A and 2B are three dimensional views of the inventive fluidic geometry as it may be implemented in a variety of inserts/housings, with FIG. 2A providing filter posts and a transverse inlet/feed within a reverse mushroom and FIG. 2B implementing a variable width exchange channel in a conventional mushroom.

FIGS. 3A and 3B are schematic representation, respectively speaking, of the geometries of FIGS. 2A and 2B. FIG. 3C is a similar schematic representation, illustrating a further variation that may be implemented on the minor island according to certain aspects of the invention.

FIG. 4A is a photograph of the spray pattern produced by the three jet island geometry schematically illustrated in FIG. 4B.

FIGS. 4C (a composite view of a conventional mushroom and three jet island geometries, both as in the prior art) and 4D (as in FIG. 7) are comparative photographs of the spray pattern for 50/50 ethanol mixtures at 0° F. and 20 psi produced by each of the fluidic geometries, thereby highlighting the uniform volume distribution and wide spray pattern of the invention in comparison to that of the prior art, with the three jet island producing a narrow jet and the mushroom producing an uneven and narrow spray fan under these conditions.

FIG. 5A is a photograph of the spray pattern produced by the fluidic geometry of various disclosed aspects of the invention, in which a comparison relative to FIG. 4A, again highlighting the comparatively more uniform volumetric distribution of the invention in comparison to the prior art.

FIGS. 5B (startup), 5C (time 1), and 5D (time 2) are sequential, schematic illustrations of the expected flow patterns in the mushroom aspect of the invention, with the arrows in these figures are representative of expected fluid flows/turbulence at a given point in time.

FIGS. 5E (startup), 5F (time 1), and 5G (time 2) are sequential, schematic illustrations of the expected flow patterns in the reverse mushroom aspect of the invention, again with the arrows in these figures are representative of expected fluid flows/turbulence at a given point in time.

FIG. 6 is a schematic top view of the fluidic geometry of FIGS. 3A and 5E, with callout 6A highlighting aspects of the comparative orientation of the power nozzle relative to one of the terminal apexes on the minor island.

FIG. 7 is a schematic top view of an alternative fluidic geometry, also relying on the two jet island concept, but in which the end of the minor island is positioned even with the protuberance defining the power nozzle.

### DETAILED DESCRIPTION

Operation of the invention may be better understood by reference to the detailed description, drawings, claims, and abstract—all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Insofar as the invention encompasses fluidic circuits, it will be understood that such inserts are typically formed in or on flat cuboid-shaped “inserts” having a length and width that are significantly larger than its thickness. Thus, the fluidic geometry can be etched, molded, or formed within the thickness, so that the expected flow will traverse the spatial plane defined by the length and the width. Typically, the inlet(s) will be positioned in, at, or near one edge, while the outlet will be formed in the opposing edge.

These inserts can be positioned within a housing that includes passageways to deliver fluid to the inlet(s) on the insert and nozzle aligned with the outlet of the insert. In one aspect, the fluidic geometry (i.e., the interaction chamber, the power nozzles, the throat/outlet, etc.) formed in or on the insert are aligned in the same spatial plane, which coincides with at least one of the major, flat surfaces of the insert. The fluidic geometry may include boundary walls formed in or on the insert, or the geometry can rely on the interior surfaces of the housing that abut the insert in order to define the fluid flow paths therein.

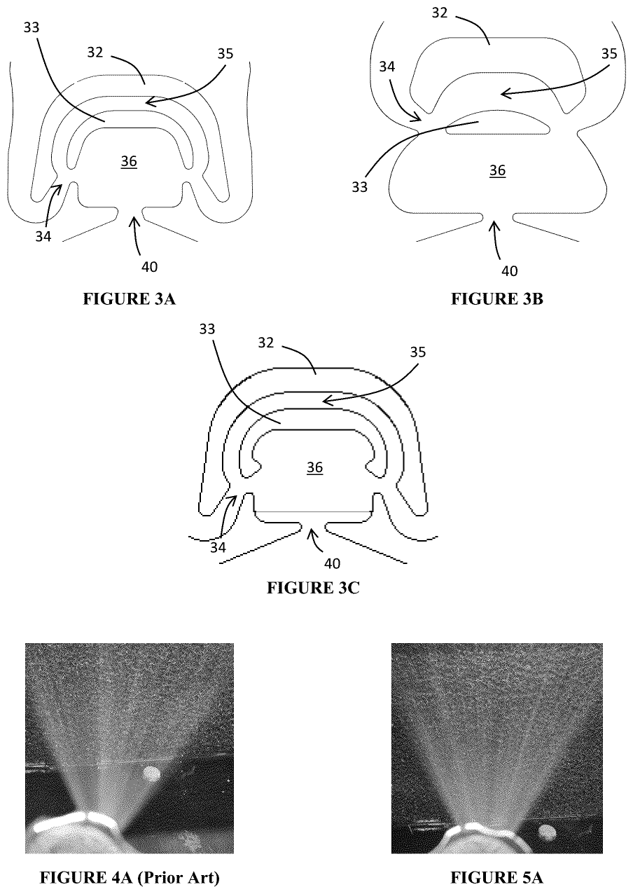

In the drawings, and particularly at least FIGS. 3A-3C, 4B, and 5A-5G, the fluidic geometry is drawn so that the inlet is at the top of each image, while the outlet is at the bottom. Flow and positioning of elements may, therefore, be described relative to these elements as either “upstream” or “downstream”. Separately, positioning of items above or at the top of the insert will be understood as tending toward the upper half in which the inlet is provided, while lower and bottom refer to those items closer to the outlet. The vertical sides in these images are the edges, with transverse and lateral directions generally running from edge to edge, whereas axial or vertical directions refer to the flow from the inlet to the outlet. The images themselves are drawn in the common spatial plane and, unless specifically noted the planar surfaces are flat and do not include any steps, ramps, or changes in elevation (relative to fluid flow across that plane).

Generally speaking, the inventive fluidic geometry is characterized by a pair of opposing power nozzles aligned in a common plane. These power nozzles are fed by one or more inlets formed as a plenum in the upstream portion of the insert. Alternatively, these inlets can be one or series of apertures passing transversely through the body (i.e., orthogonal to the common plane) of the insert.

Notably, the power nozzles are not aligned on the axial centerline A-A of the insert (i.e., the line passing through the middle of the housing and, usually, through the middle of the outlet and throat), largely because a first large or major island is positioned upstream from these power nozzles, with its transverse edges defining one side of each power nozzle, and the peripheral wall defining the entirety of the circuit/geometry (either on the insert itself or as part of the cavity in the housing receiving the insert) defines the opposing side of that power nozzle.

A second, smaller or minor island is spaced apart downstream from the major island, so that the minor island is disposed within the interaction chamber. This smaller island stretches transversely from edge to edge of the insert and across the common plane and positioned symmetrically around the centerline axis. In some aspects, this smaller island has an upstream facing whose shape partially or completely conforms to, and in some cases remains equidistantly spaced apart, from the downstream facing of the major island. The shape of the minor island may include: a) a crescent-like shape in which the edges are thinner from upstream to downstream facings in comparison to along the centerline axis (e.g., as in FIG. 3A, b) a flat/horizontal downstream facing and a curved or semicircular upstream facing (thereby imparting a “speed bump” appearance, e.g. as in FIG. 3B), or c) a C-shape including “serif” style thickened portions at the edges, so as to protrude into the interaction chamber and provide a mushroom cap appearance (e.g., as in FIG. 3C).

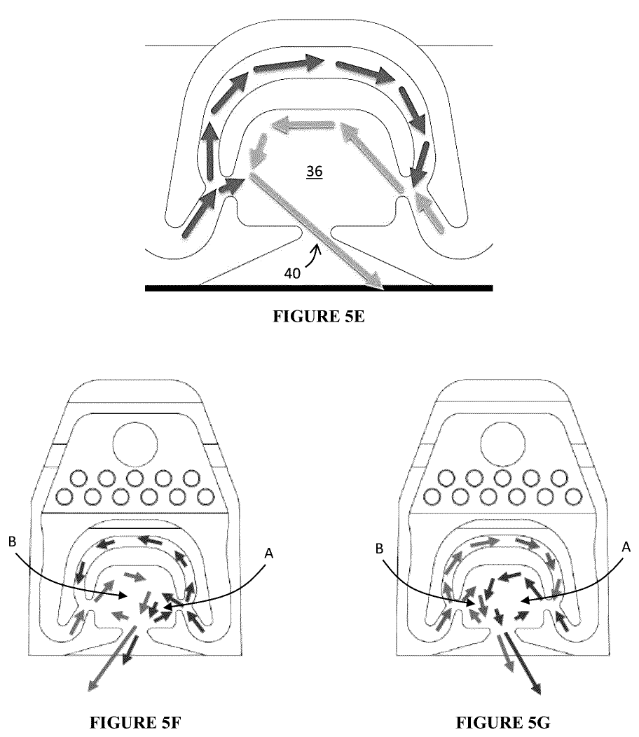

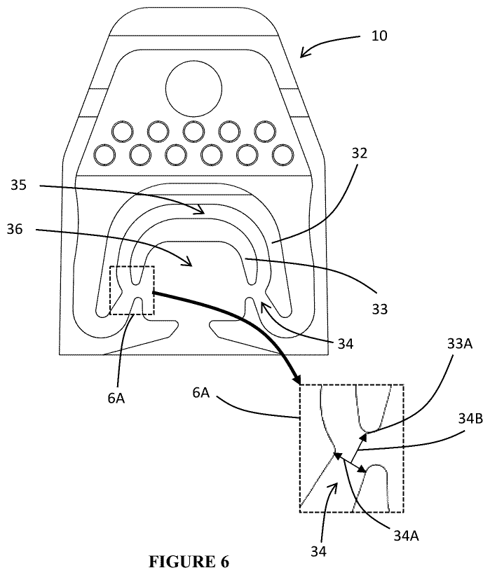

The terminal/outermost edges of the minor island are defined by edge or apex 33A positioned within the initial flow path created by that power nozzle as fluid exits the nozzle and flows toward the interaction chamber (note: while this is nominally downstream, certain aspects like those shown in FIGS. 5E-5G may have the power nozzle directed upward at an angle back toward the inlet). Generally speaking, the positioning of the edges 33A fall within a pair of imaginary straight lines extending from the straight sidewalls that define the power nozzle 34, thereby providing lateral boundaries (i.e., the “mouth” of the power nozzle) in which the apex 33A will be positioned. More specifically and with reference to FIG. 6, if a straight line 34A is drawn across the opening at the mouth of the power nozzle 34, an offset line 34B extends orthogonally from line 3A so as to intersect with the apex 33A, and the length of orthogonal line 34B will be about the same as, less than double, or less than the length of the straight line 34A.

The positioning of each edge of the minor island within the immediate range at the mouth of each power nozzle, as described in the preceding paragraph, will divide the flow ejected from each power nozzle so that at least a portion of the flow from each will be directed into the interaction chamber. In some aspects, flow from one power nozzle is split between entering the interaction chamber and the exchange channel (as defined below) while flow from the opposing power nozzle is directed into the interaction chamber until the flow patterns cause a reversal which is believed to account for the insert's ability to produce an oscillating flow pattern (e.g., compare FIGS. 5C vs. 5D and 5E vs. 5F), although it will be understood the inventors do not necessarily intend to be bound based on a theory of operation. Furthermore, the numerous examples of oscillating fluidic circuits (including those detailed in the Background of Invention above) make it clear that fluidics can be a complicated and unpredictable endeavor in which slight changes to the geometry can result in significant and useful improvements.

The provision of a minor island axially below and along a downstream facing of the major island creates and defines an exchange channel. The openings at the opposing ends of the exchange channel are placed adjacent to and slightly above/upstream from the mouth of each power nozzle. In operation, it is believed that a portion of fluid flow emanating out of the power nozzle is partially or almost completely diverted through the exchange channel, and the main flow of fluid will reverse in a regular pattern. As a result, temporary vortices are formed and shift within the interaction chamber as fluid flows from the inlet through the outlet (e.g., see FIGS. 5C through 5F), thereby producing an oscillating spray pattern out of the throat. Notably, the exchange channel will be more narrow along its entire length (i.e., transverse to the expected flow path) in comparison to the transverse width or the axial height of the interaction chamber at its most narrow point.

Another feature of the fluidic geometry is that the major and minor islands can be symmetric about the centerline axis. Further, the minor island will have a transverse width that is smaller in comparison to the major island and, because it defines the upper boundary of the interaction chamber, the major island must always possess a larger maximum transverse width in comparison to any portion of the minor island.

In some aspects, the lower-most edge of the minor island will be largely or completely level with or above the lower-most edge of the power nozzle. However, the major island may extend axially below the downstream edge of the minor island (see FIGS. 3A and 3C). In terms of surface area, the majority (see FIGS. 3A and 3C) or the entirety (see FIG. 3B) of the major island and, separately, the entirety of the minor island will occupy an axial position that is the same as or above the lower/downstream edge of the power nozzles.

Also, the downstream facings of the interaction chamber will curve from the protuberance that defines the downstream portion the power nozzle into a straight, horizontal line leading to the outlet. That is, the lower-most wall of the interaction chamber will include walls immediately adjacent to both side of the throat/outlet that run along a straight edge orthogonal to the centerline axis of the insert. In some aspect, the horizontal section of each wall is within +/−10% of the width of the outlet at its narrowest point. Additional aspects have the horizontal section of each wall on the lower-most edge of the interaction chamber running transversely at a size that is at least the same, up to twice as large, or up to three times as large as the width of the outlet at its narrowest point.

In some aspects, the widest transverse width of the interaction chamber will be greater than that of the exchange channel (see FIG. 3B). In alternative aspects, the exchange channel will, at its widest point, have a larger transverse width than the interaction chamber at its widest point (see FIGS. 3A and 3C).

The startup condition and flow pattern are seen in FIG. 5B. The circuit will naturally allow one side to start as the dominant exit flow (represented by the set of arrows on the right-hand side of the drawing, although it will be understood that any number of variables may dictate whether the right or left side of the insert will be dominant at startup). As the left hand flow is blocked, a portion of the jet from that power nozzle is diverted through the exchange channel as seen in FIG. 5C, with the remaining flow being partially or completely diverted by the dominant stream so as to create clockwise vortex B in the lower left corner of the interaction chamber. Similarly, as diverted flow exits the exchange channel, it may fuse with the dominant flow and/or peel away so as to create clockwise vortex A in the lower right corner of the interaction chamber. Owing the tendency for fluid flow to attach to or be influenced/impacted by the peripheral wall, vortices A and B will wax and wane in terms of their size and strength. Thus, as seen FIG. 5D, when vortex A is sufficiently large, the exiting jet, while internal to the interaction region, will be pushed from the right to the left, switching the exiting jet left hand exit to right hand exit. As such, the geometry will regularly switch back and forth, with a corresponding effect and impact upon the spray dispensed from the outlet (i.e., this contributes to the oscillation and varying volume proportion across the spray fan).

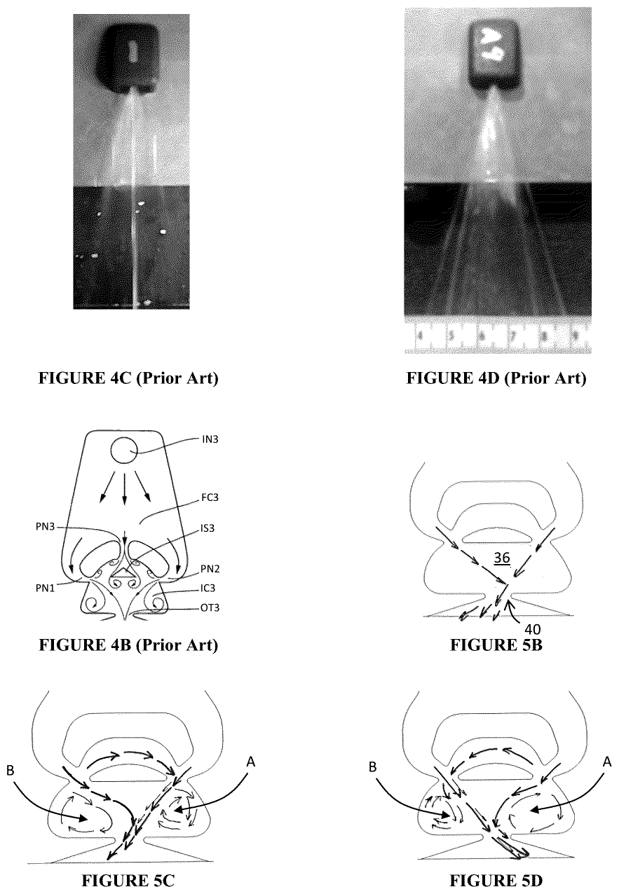

FIGS. 4D and 5A illustrate that these spray patterns are more uniform (i.e., the volumetric distribution across the fan has less variability) in comparison to conventional circuits, such as the three jet island depicted in FIGS. 4A and 4C. Equally important, the inventive geometries of FIGS. 3A and 3B (and as otherwise described or contemplated herein) show more consistent performance across a wide range of temperatures, flow conditions, and fluid types.

Without wishing to be bound by any particular theory of operation, the inventors believe the exchange channel may serve as a type of inertance loop. Accordingly, United States' patent publication 2023/0355470 and U.S. Pat. No. 9,765,491 are both incorporated by reference herein. Generally speaking, an inertance loop can be employed to create desired flow conditions (e.g., instability and/or oscillations in output spray that go along with it). With reference to FIGS. 5B through 5F, adjustments to and/or deliberate variations along the length, diameter, height, and/or width of the exchange channel can be made in order to impact the flow patterns through and emanating from it.

For example, as seen in FIG. 3A, the small island can be extended across the width of the interaction chamber to increase the length of the exchange channel. Axially aligned extensions on that minor island can further extend and lengthen the exchange channel.

FIG. 3B represents an alternative or additional way to influence the inertance effects of the exchange channel. Here, the curvature on the upstream facing of the minor island varies in comparison to the curvature on the downstream facing of the major island. This arrangement imparts a variable width along the exchange channel, creating the potential for Venturi effects that further influence the flow patterns and vortices described herein.

FIG. 5E specifically illustrates this inertance effect. The flow from right power nozzle (lighter colored arrows) dominates and loops around the interaction chamber (possibly attaching to and/or interacting with features on the downstream facing of the minor island). This flow pattern blocks off the less dominant left power nozzle (darker colored arrows) and reroutes flow from left nozzle down towards the throat and/or into the exchange channel. Eventually, the opposing power nozzle will overpower the dominant nozzle so that the flows “switch” and follow a regular cycle.

The diversion of flow created by the exchange channel acts as a type of an inertance loop, as disclosed in the references noted above. It is known that inertance loops can be used to tune frequencies in feedback loop geometries, but the inventors are unaware of any similar structure or process provided within the interaction chamber itself, i.e., in the same planar surface, without needing to divert or redirect flow through an aperture in the body or a passage formed in the housing (either of which meets at an angle-usually orthogonal-relative to the planar surface/direction of the inventive geometry). The higher the inertance of the exchange channel, the slower the pressure wave will travel to the other side of the circuit, and the longer the jet will linger at the edge position of the fan. A lower inertance value of that loop will cause the pressure wave to propagate faster to the other side of the circuit, causing the jet to flip to the other side of the fan faster after hitting the end, improving the uniformity of the spray. As such, the invention also includes a method of controlling, altering, and fine tuning the oscillation and spray pattern characteristics produced by the fluidic geometries contemplated herein.

As shown herein, smooth, symmetrical C-shaped curves may be preferred for the upstream facing of the minor island and the downstream facing of the major island (as well as the upstream facing of the major island, although that facing will not play a direct role in the flow patterns and characteristics of the exchange channel). The downstream facing of the minor island can also be a smooth, symmetrical C-shaped curve (e.g., FIG. 3A), although it is possible to impart it with a straight line, preferably aligned orthogonally to the centerline axis (e.g., FIG. 3B). The transversely opposed ends of the minor island may be inset from the power nozzle openings (e.g., FIG. 3B), or they may align with extensions, fingers, or protuberances on the peripheral wall that help define the downstream side of the power nozzle (FIG. 3A).

FIG. 3C provides an example of how the downstream facings of the minor island can be further modified. As shown, small and preferably mirror-image projections can added on those inner facings (effectively creating serif-style C). Features such as this can be instrumental in detaching the fluid flow from the inside walls, particularly in high viscosity conditions. In a similar manner, an apex projection (as described in United States' patent publication 2021/0114044) can be used as an additional or alternative implementation on the downstream/interaction-chamber-facing of the minor island.

The major island can, in some instances, be imparted with fingers, extensions, or protuberances on the inner, downstream facings in order to define the top/upstream side of the power nozzle (FIG. 3A). In these instances, the finger/extension/protuberance helps to define the angle and, possibly, the extent to which the jet emanating from that power nozzle will be initially diverted into the exchange channel (as opposed to entering the interaction chamber).

Notably, so long as the fluidic geometry relies upon two opposing power nozzles feeding an interaction chamber, the two-jet island approach contemplated herein can be adapted to function with those geometries (along with any improvements or additives features thereto). As will be understood in this field, a power nozzle necessarily involves the use of a narrowing or constricted flow path so as to create directed fluid jet that is introduced into the interaction chamber and, as such, a power nozzle is not: a) a simple flow path around an obstruction, and b) the throat at the outlet of any fluidic geometry (insofar as this feature ejects the final spray fan and does not connect to the interaction chamber).

Notably, neither of the power nozzles will be located on the centerline axis (or otherwise positioned on a straight line running between the inlet and the outlet when both the inlet and outlet are situated in the central portion of the insert/chip/housing). In the same manner, the minor island and/or the power nozzles are preferably symmetrical about that centerline axis, meaning they can form a mirror image relative to the centerline axis.

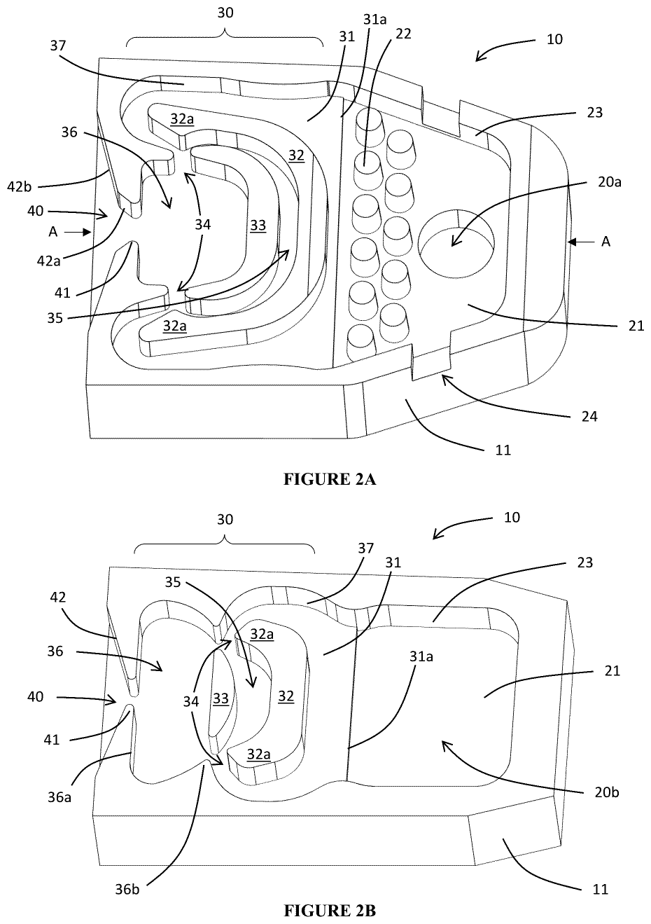

In FIGS. 2A and 2B, the insert 10 is cuboid or polygonal body 11 with features carved, etched, or formed into one or both of the two major planar facings. One or more inlets are formed as apertures 20a or a plenum 20b (in which the adjacent housing defines and includes the aperture(s) through which fluid is introduced to that plenum). These inlets are disposed at an opposite region of the body 11 in comparison to the outlet 40. The edges/sides of the body 11, along with portions of the planar facings that might be expected to come into contact with a nozzle housing (not shown), may include angled, ramped, or specially shaped regions to facilitate those connections, with the further understanding that the insert 10 is received in the nozzle housing in a sealed manner so that fluid flows through the inlet 20, across the geometry 30, and is dispensed from the outlet 40 without significant leakage, loss of pressure, etc. Notably, the anticipated fit/interface between the insert 10 and the housing (or other system parts) enables designs in which portions of the peripheral wall, within the geometry 40 or otherwise, can actually be established by the housing/other parts. Similarly, the open facing of the geometry 40 (on one or both sides) will be sealed by corresponding planar faces in the housing/other parts.

The inlet 20, geometry 30, and outlet 40 are bounded by a sunken or inset floor that is bounded by peripheral walls (formed by the body 11 and/or the housing). In the region proximate the inlet(s), this floor defines flow passage 21. A series of posts or pillars 22, substantially matching the height of the other blocking components defining the geometry 30 (i.e.,the peripheral walls, major and minor islands, etc.) may be spaced apart and arranged in a line or regular pattern to serve as a filter to prevent debris from entering the geometry 30, thereby reducing the risk of blockages. The peripheral walls 23 may include notches, guides, or other indexing means 24 to insure the insert 10 is located and fitted properly within the housing. Walls 23 direct flow from the inlet(s) 20 toward the geometry 30.

The geometry 30 is defined at its boundaries by curving and/or angles peripheral walls 37. A major island 32 is positioned in the middle of the floor 31, so that fluid can pass around its outer transverse edges. Floor 31 may include a stepped section 31a that demarcates a transition from the flow passage 21 associated with the inlet 20 to the actual geometry 30. As seen herein, the floor 31 throughout the geometry will remain within the same common plane. The terminal or opposing transverse ends 32a of the major island 32 define one side (i.e., the upstream edge) of the power nozzles 34, and ends 32a may include protrusions or other features as notes elsewhere herein (e.g., see FIG. 3C). The opposing side of the power nozzles 34 will be formed by the walls 37 and, more specifically, by the protuberances 36b within the interaction chamber 36. In this manner, the power nozzles 34 each direct a fluid jet toward the opposing/tranverse ends of the minor island 33.

Minor island 33 is spaced apart but downstream from the major island 32. Island 33 also has the various features and characteristics noted elsewhere herein, while the passageway between islands 32, 33 defines the exchange channel 35. As such, channel 35 has opposing ends that are in partial fluid communication with the jets output by the power nozzles 34 and, separately, with the interaction chamber 36.

Interaction chamber 36 is devoid of any obstructions or features (excepting island 32). The chamber 36 will have a common fluidic geometric configuration, with curving periphery that may define a mushroom, a reverse mushroom, or other shapes. In some aspects, the downstream walls defining the chamber 36 may be orthogonal to the centerline axis A-A, although curved and/or angled sections emanate from the downstream edge of the power nozzles 34 to the outlet 40. The outlet 40 can be defined by a throat opening in the lower facing of the interaction chamber 36, with straight edge walls 36a (i.e., running perpendicular to the centerline axis A-A) extending in opposite directions away from the throat and then curving upward to form opposing protuberances 36b that define one side (i.e., the downstream edge) of the power nozzles 34.

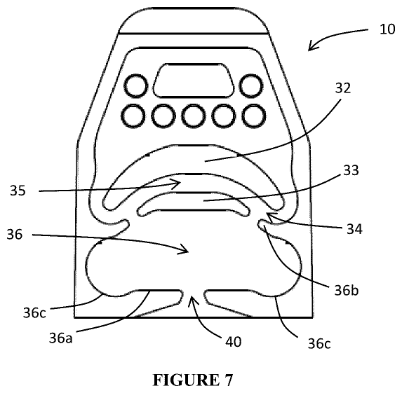

In a further aspect shown in FIG. 7, it is possible to align each of the edges 33A of the minor island 33 at the downstream edge of the power nozzle 34 (i.e., in line with the curvature of the protuberance 36b) but still within the prescribed distances noted above (i.e., less than twice the width of the power nozzle and, more preferably, at about the same spacing as the width of the power nozzle). This arrangement effectively directs the majority of the jet from the power nozzles into the exchange channel 35. Here, a radius curved section 36c is positioned in the lower transverse corners of the interaction chamber 36, so as to form a bulbous depression or dip on the outer edge of each straight wall section 36a. The lower most edge of the bulbous depression 36c will be positioned closer to the bottom edge of the insert (along an axial line) in comparison to the straight wall section 36a.

In the aspect of FIG. 7, this arrangement creates a “flatter” minor island that is more akin to the speed bump of FIG. 3B, but with a narrower exchange channel 35 whose width remains largely consistent along its entire length (i.e., the spacing between the major and minor island does not vary or, at most, it varies by less than 10% or 5% with the widest section falling on the centerline axis). The other features and characteristics of the inventive fluidic geometry still apply to this particular aspect.

Outlet 40 may be positioned on axis A-A on the downstream edge of the body 11. The outlet 40 is characterized by a narrow throat 41, which joins with the downstream walls of the chamber 36. On the opposing edge of throat 41, exit walls 42 diverge from one another to define the outlet 40 that is visible on the edge of the body 11. In some aspects, exit walls 42 may include discrete sections 42a, 42b that are angle relative to one another. As noted elsewhere herein, it may be possible to dispose additional structural feature in, on, or adjacent to the throat/outlet.

In view of the foregoing, one aspect of the invention contemplates a fluid insert for producing an oscillating spray pattern at low temperatures. This insert is formed by a body defining an inlet positioned within an upper portion of the body and an outlet positioned at a lower edge the body so that fluid flows in a common spatial plane along a major facing of the body from the inlet to the outlet. A major island and a minor island are formed symmetrically on the major facing around a centerline axis of the body and wherein the major island: i) is positioned closer to the inlet in comparison to the minor island, ii) includes a lower edge that is spaced apart from an upper edge of the minor island so as to define an exchange channel, and iii) has a larger maximum transverse width in comparison to the minor island. An interaction chamber is positioned between the inlet and the outlet and having: i) an upper facing defined by a lower edge of the minor island, and ii) a lower facing including a pair of straight edge wall sections emanating in opposite directions from an opening defining the outlet, extending perpendicular to the centerline axis for a wall distance, and thereafter curving axially upward to define opposing protuberances. Lastly, opposing power nozzles defined by the opposing protuberances and opposing transverse ends of the major island are provided and positioned so that each power nozzle directs a fluid jet toward opposing transverse ends of the minor island. Additional aspects may include any one or combination of the following features:
wherein the minor island is a crescent, a C-shape, or a speed bump-shape;
wherein the opposing transverse ends of the minor island include thickened portions to impart a serif-style C-shape;
wherein the lower edge of the major island is spaced apart from the upper edge of the minor island at a substantially constant distance along all of the exchange channel;
wherein the interaction chamber has a reverse mushroom configuration;
wherein the wall distance is equal to or up to three times greater than an outlet distance defined by a narrowest point between the pair of straight edge wallsections defining the outlet;
wherein the opposing transverse ends of the major island are positioned axially closer to the lower edge of the body in comparison to the opposing protuberances;
wherein a power nozzle width is defined as a narrowest point between the opposing protuberance and the opposing transverse end of the major island for each power nozzle, wherein a minor island spacing is defined as a shortest distance between the opposing transverse end of the minor island and the power nozzle associated therewith, and wherein the minor island spacing is less than double the power nozzle width;
wherein a floor formed on the major facing includes a stepped section between the inlet and the major island; and
wherein a bulbous depression is interposed between each straight edge wall section and the protuberance associated therewith.

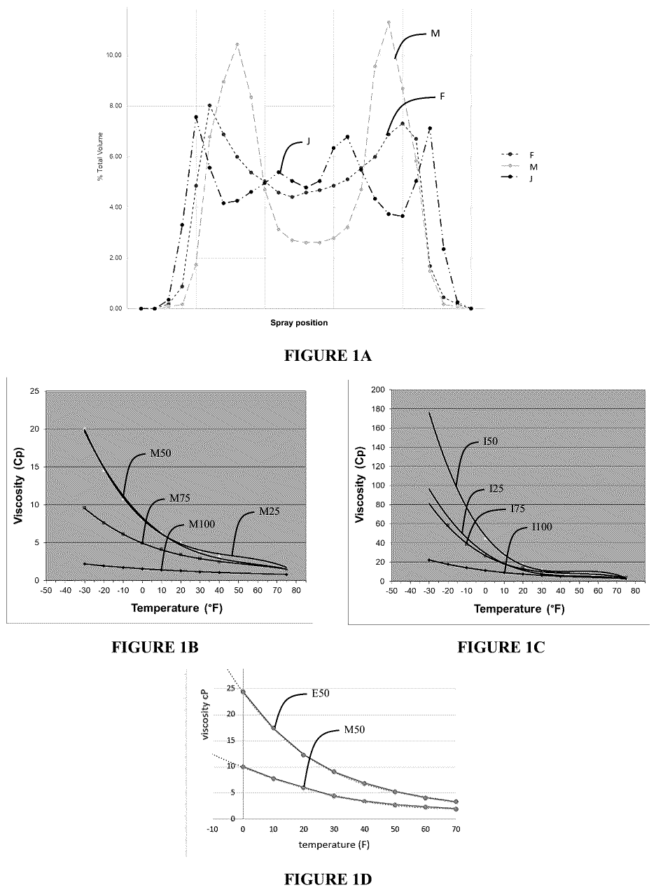

A further aspect of the invention is an oscillating spray nozzle including any of the aforementioned iterations of the fluidic insert. A method for producing an oscillating spray using any of these insert is also contemplated. In all of the aforementioned aspects, the oscillating spray produced thereby will retain its desired characteristics (shape, volumetric distribution, etc.) across a broad range of temperatures and fluid mixtures, including those contemplated in FIGS. 1B and 1C. Further still, in each of these aspects, fluid from the inlet flows around both of the transverse opposing ends the major island so as produce a pair of vortices within the interaction chamber that alternate in strength and/or fluid flows in the exchange channel to create an inertance loop that is alternately fed by only one of the power nozzles and, in either/both cases, the fluid flow patterns create and sustain an oscillating spray in the fluid that is ejected from the outlet.

As used herein, axial and the axial or lengthwise direction refers to the general direction of flow from the inlet, through the fluidic geometry, and as dispensed as a spray pattern from the outlet. Thus, as a single and non-limiting example, the axial direction in FIGS. 3A-3C coincides with the vertical direction. Accordingly, throughout the drawings and this disclosure, the transverse or widthwise direction intersects an axial line at a right angle. In all cases, these and other terms should be read in context of the disclosure and the language commonly used in this field.

All components should be made of materials having sufficient flexibility and structural integrity, as well as a chemically inert nature and resistant to corrosion and other conditions commonly encountered by exterior vehicle components. Certain grades of injection-moldable polymers may be particularly advantageous, as will various processes for forming detailed shapes in/on metallic, polymeric, composite, or other types of blocks of materials. Additive manufacturing methods may also be useful.

References to coupling in this disclosure are to be understood as encompassing any of the conventional means used in this field. This may take the form of snap-or force fitting of components, although threaded connections, bead-and-groove, and bayonet-style/slot-and-flange assemblies could be employed. Adhesive and fasteners could also be used, although such components must be judiciously selected in view of the design considerations noted above.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

We claim:

1. A fluid insert for producing an oscillating spray pattern at low temperatures, the insert comprising:
a body defining an inlet positioned within an upper portion of the body and an outlet positioned at a lower edge the body so that fluid flows in a common spatial plane along a major facing of the body from the inlet to the outlet;
a major island and a minor island each formed symmetrically on the major facing around a centerline axis of the body and wherein the major island: i) is positioned closer to the inlet in comparison to the minor island, ii) includes a lower edge that is spaced apart from an upper edge of the minor island so as to define an exchange channel, and iii) has a larger maximum transverse width in comparison to the minor island;
an interaction chamber positioned between the inlet and the outlet and having: i) an upper facing defined by a lower edge of the minor island, and ii) a lower facing including a pair of straight edge wall sections emanating in opposite directions from an opening defining the outlet, extending perpendicular to the centerline axis for a wall distance, and thereafter curving axially upward to define opposing protuberances; and
opposing power nozzles defined by the opposing protuberances and opposing transverse ends of the major island; and
wherein the power nozzles each direct a fluid jet toward opposing transverse ends of the minor island.

2. The fluidic insert of claim 1 wherein the minor island is a crescent, a C-shape, or a speed bump-shape.

3. The fluidic insert of claim 1 wherein the opposing transverse ends of the minor island include thickened portions to impart a serif-style C-shape.

4. The fluidic insert of claim 1 wherein the lower edge of the major island is spaced apart from the upper edge of the minor island at a substantially constant distance along all of the exchange channel.

5. The fluidic insert of claim 1 wherein the interaction chamber has a reverse mushroom configuration.

6. The fluidic insert of claim 1 wherein the wall distance is equal to or up to three times greater than an outlet distance defined by a narrowest point between the pair of straight edge wall sections defining the outlet.

7. The fluidic insert of claim 1 wherein the opposing transverse ends of the major island are positioned axially closer to the lower edge of the body in comparison to the opposing protuberances.

8. The fluidic insert of claim 1 wherein a power nozzle width is defined as a narrowest point between the opposing protuberance and the opposing transverse end of the major island for each power nozzle, wherein a minor island spacing is defined as a shortest distance between the opposing transverse end of the minor island and the power nozzle associated therewith, and wherein the minor island spacing is less than double the power nozzle width.

9. The fluidic insert of claim 1 wherein a floor formed on the major facing includes a stepped section between the inlet and the major island.

10. The fluidic insert of claim 1 wherein fluid from the inlet flows around both of the transverse opposing ends the major island so as produce a pair of vortices within the interaction chamber and wherein the vortices alternate in strength so as to create an oscillating spray in the fluid that is ejected from the outlet.

11. The fluidic insert of claim 1 wherein the exchange channel serves as an inertance loop that is alternatively fed by only one of the power nozzles so as to sustain an oscillating spray in the fluid that is ejected from the outlet.

12. The fluidic insert of claim 1 wherein a bulbous depression is interposed between cach straight edge wall section and the protuberance associated therewith.
